(19) United States
(12) Patent Application Publication
(10) Pub. No.: US 2023/0156394 A1
(43) Pub. Date: May 18, 2023

(54) ELECTRONIC DEVICE FOR SENSING TOUCH INPUT AND METHOD THEREFOR

(71) Applicant: SAMSUNG ELECTRONICS CO., LTD., Suwon-si (KR)

(72) Inventors: Yunguk LEE, Suwon-si (KR); Jaewon KIM, Suwon-si (KR); Hayeon CHO, Suwon-si (KR); Jaewon CHOI, Suwon-si (KR); Seungnyun KIM, Suwon-si (KR); Wonhee LEE, Suwon-si (KR); Jaehyuk CHOI, Suwon-si (KR)

(21) Appl. No.: 18/096,197

(22) Filed: Jan. 12, 2023

Related U.S. Application Data
(63) Continuation of application No. PCT/KR2021/005252, filed on Apr. 26, 2021.

(30) Foreign Application Priority Data
Jul. 24, 2020 (KR) 10-2020-0092509

(51) Int. Cl. H04R 1/10; G06F 3/041

(52) U.S. Cl. CPC H04R 1/1041; G06F 3/0416

(57) ABSTRACT

Disclosed is an electronic device including: at least one sensor including a proximity sensor, a touch sensor, and a processor operatively connected with the at least one sensor and the touch sensor. The processor is configured to: detect a distance between an external object and the electronic device using the proximity sensor, disable the touch sensor or ignore a signal from the touch sensor based on the distance between the external object and the electronic device being less than a certain distance, determine whether the electronic device meets a specified condition based on a sensing value obtained from the at least one sensor, and enable the touch sensor or recognize the signal from the touch sensor based on the electronic device meeting the specified condition.

### CROSS-REFERENCE TO RELATED APPLICATIONS

This application is a continuation of International Application No. PCT/KR2021/005252 designating the United States, filed on Apr. 26, 2021, in the Korean Intellectual Property Receiving Office and claiming priority to Korean Patent Application No. 10-2020-0092509, filed on Jul. 24, 2020, in the Korean Intellectual Property Office, the disclosures of which are incorporated by reference herein in their entireties.

### BACKGROUND

### Field

The disclosure relates to an electronic device for sensing a touch input and a method therefor.

### Description of Related Art

A wearable electronic device (e.g., wireless earphones) used by being worn on a body’s part (e.g., ears) of a user may include a touch sensor and/or a touch IC. For example, for a wireless earphone, the touch sensor may be disposed on the outside of a housing of the wireless earphone.

The wearable electronic device may receive a touch input of the user using the touch sensor. The touch IC may receive the touch input received through the touch sensor and may convert the touch input into an electrical signal. The wearable electronic device may provide various functions according to the touch input of the user. For example, when the user touches the wearable electronic device (e.g., the wireless earphone) once (1 tap), the wearable electronic device may play music. For example, when the user touches the wearable electronic device (e.g., the wireless earphone) twice (2 taps), the wearable electronic device may play next music in the playlist. For example, the touch input of the user may include 1 Tap/2 Tap/3 Tap/Long Press.

Receiving a user input through a touch sensor, a wearable electronic device (e.g., wireless earphones) may recognize all of touches of a user, which are input to the touch sensor, as user inputs. The touches of the user may include a touch which is not intended by the user. For example, in the process where the user wears the wearable electronic device (e.g., the wireless earphones), the user may adjust a location of the wearable electronic device to ensure a comfortable fit. In the process of adjusting the wearable electronic device, a body’s part (e.g., a finger) of the user may come into contact with the touch sensor of the electronic device. When the wearable electronic device recognizes the touch input of the user as being valid and executes a function (e.g., music playback) according to it, a malfunction of the electronic device due to an unintended input of the user may occur.

Furthermore, for a wearable electronic device of a new design, a probability of a malfunction of the wearable electronic device due to the unintended touch input of the user may increase as there is a lack of learning about an initial wearing method of the user.

### SUMMARY

In accordance with an example embodiment of the disclosure, an electronic device is provided. The electronic device may include: at least one sensor including a proximity sensor, a touch sensor, and a processor operatively connected with the at least one sensor and the touch sensor. The processor may be configured to: detect a distance between an external object and the electronic device using the proximity sensor, disable the touch sensor or ignore a signal from the touch sensor based on the distance between the external object and the electronic device being less than a certain distance, determine whether the electronic device meets a specified condition based on a sensing value obtained from the at least one sensor, and enable the touch sensor or recognize the signal from the touch sensor based on the electronic device meeting the specified condition.

In accordance with an example embodiment of the disclosure, a method of operating an electronic device is provided. The method may include: detecting a distance between an external object and the electronic device using a proximity sensor, disabling a touch sensor or ignoring a signal from the touch sensor based on the distance between the external object and the electronic device being less than a certain distance, determining whether the electronic device meets a specified condition based on a sensing value obtained from at least one sensor, and enabling the touch sensor or recognizing the signal from the touch sensor based on the electronic device meeting the specified condition.

According to various example embodiments disclosed in the disclosure, the electronic device may disable a touch sensor until a specified condition is met after the wearing of the user is detected, thus preventing and/or reducing a malfunction caused by an unintended input of the user in the wearing process of the user.

According to various example embodiments disclosed in the disclosure, the electronic device may execute a function of the electronic device in response to a user input meeting a certain condition, thus preventing and/or reducing a malfunction caused by an unintended input of the user after the wearing of the user is completed.

In addition, various effects ascertained directly or indirectly through the disclosure may be provided.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment, according to various embodiments;

FIG. 2 is a diagram illustrating an example structure of an electronic device according to various embodiments;

FIG. 3 is a block diagram illustrating an example configuration of the electronic device according to various embodiments;

FIGS. 4A and 4B are flowcharts illustrating example operations of an electronic device for preventing/reducing a malfunction according to various embodiments;

FIG. 5 is a flowchart illustrating an example operation of FIG. 4A according to various embodiments;

FIG. 6 is a graph illustrating a change in sensing value of a proximity sensor according to various embodiments;

FIG. 7 is a flowchart illustrating an example operation of FIG. 4A according to various embodiments;

FIG. 8 is a flowchart illustrating an example operation of FIG. 4A according to various embodiments;

FIG. 9 is a flowchart illustrating an example method for improving accuracy of a touch input according to various embodiments; and

FIG. 10 is a flowchart illustrating an example operation of an electronic device according to a power state according to various embodiments.

With respect to the description of drawings, the same or similar denotations may be used for the same or similar components.

### DETAILED DESCRIPTION

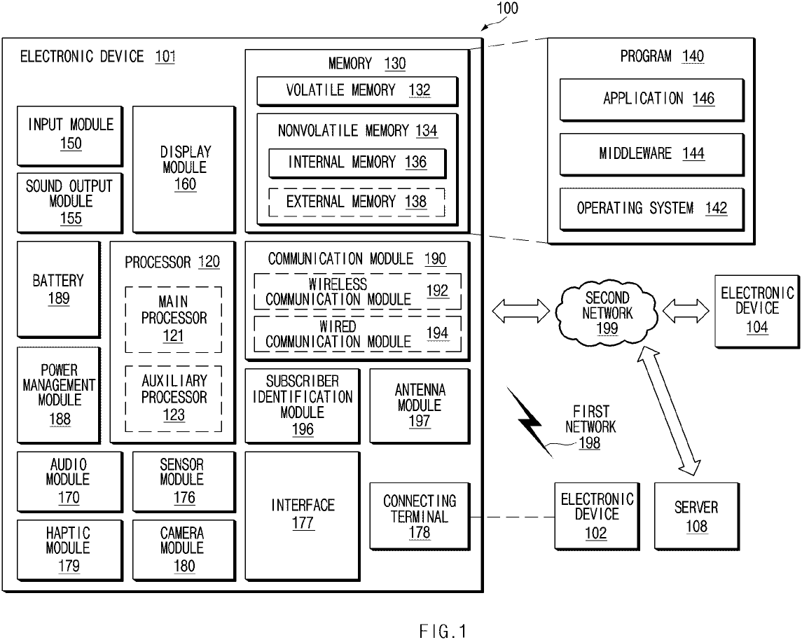

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element include a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer’s server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

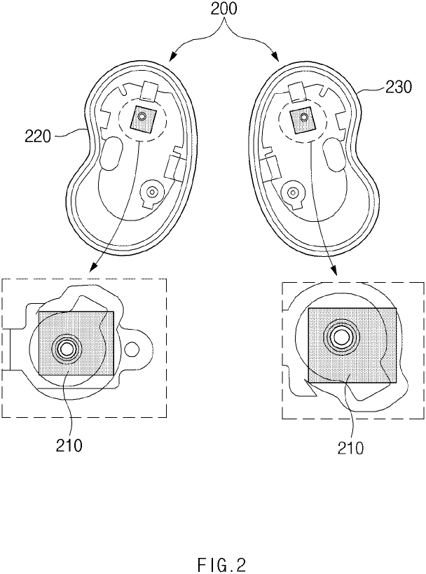

FIG. 2 is a diagram illustrating an example structure of an electronic device according to various embodiments.

According to an embodiment, an electronic device 200 (e.g., an electronic device 101 of FIG. 1) may be understood as a wearable electronic device (e.g., wireless earphones). For example, the electronic device 200 may include a left-use unit (e.g., including various circuitry) 220 and a right-use unit (e.g., including various circuitry) 230. The left-use unit 220 may be designed to be suitable for the left ear of a user, and the right-use unit 230 may be designed to be suitable for the right ear of the user.

According to an embodiment, the electronic device 200 may include a touch area 210. The touch area 210 may be formed at an outer side of a housing of the electronic device 200. The user may perform a touch input on the touch area 210 to execute a function of the electronic device 200.

The user may wear the left-use unit 220 and the right-use unit 230 on portions (e.g., the left ear and the right ear) of the body, which respectively corresponding to them. The user may wear the electronic device 200 and may then adjust a location of the electronic device 200 to ensure a more comfortable fit. In the process of adjusting the location of the electronic device 200, a body’s part (e.g., a finger) of the user may come into contact with the touch area 210. To prevent and/or reduce a malfunction due to an unintended touch input of the user, the electronic device 200 may disable a touch sensor located in the touch area or may ignore a signal from the touch sensor until the adjustment of the location of the electronic device 200 is completed. The electronic device 200 may determine whether the adjustment of the location of the electronic device 200 is completed using at least one sensor (e.g., a sensor module 176 of FIG. 1).

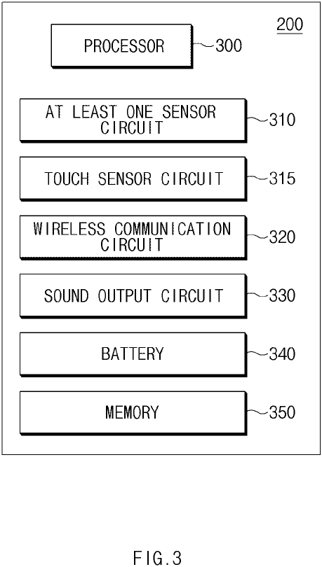

FIG. 3 is a block diagram illustrating an example configuration of the electronic device according to various embodiments.

According to an embodiment, an electronic device 200 (e.g., an electronic device 101 of FIG. 1) may include a processor (e.g., including processing circuitry) 300 (e.g., 120 of FIG. 1), at least one sensor circuit 310 (e.g., a sensor module 176 of FIG. 1), a touch sensor circuit 315 (e.g., the sensor module 176 of FIG. 1), a wireless communication circuit 320 (e.g., a communication module 190 of FIG. 1), a sound output circuit 330 (e.g., a sound output module 155 of FIG. 1), a battery 340 (e.g., 189 of FIG. 1), and/or a memory 350 (e.g., a memory 130 of FIG. 1). The configuration of the electronic device 200 shown in FIG. 3 is illustrative, and embodiments of the disclosure are not limited thereto. For example, the electronic device 200 may fail to include a component (e.g., the sound output circuit 330 or the battery 340) shown in FIG. 3.

The processor 300 may be operatively connected with the at least one sensor circuit 310, the touch sensor circuit 315, the wireless communication circuit 320, the sound output circuit 330, the battery 340, and/or the memory 350. The processor 300 may include various processing circuitry and control the components of the electronic device 200. For example, the processor 300 may control the components of the electronic device 200 depending on one or more instructions stored in the memory 350. The processor 300 may include an application processor and/or a communication processor. The processor 300 may include one chip or a plurality of chips.

The at least one sensor circuit 310 may detect an operation state (e.g., power) of the electronic device 200 or an external environment state (e.g., a user state) and may generate an electrical signal or a data value corresponding to the detected state. According to an embodiment, the at least one sensor circuit 310 may include, for example, a gesture sensor, a gyro sensor, an acceleration sensor, a grip sensor, a proximity sensor, a color sensor, an infrared (IR) sensor, and/or a biometric sensor.

The touch sensor circuit 315 may receive a touch input of the user. The touch sensor circuit 315 may include a touch sensor and/or a touch integrated circuit (IC). The touch sensor may detect a touch input of the user. The touch IC may convert the detected user input into an electrical signal. The touch IC may be designed together with the processor 300 on one chip or may be designed independent of the processor 300.

The wireless communication circuit 320 may establish a wireless communication channel between the electronic device 200 and an external electronic device (e.g., an electronic device 102, an electronic device 104, or a server 108 of FIG. 1) and may assist in performing communication over the established communication channel. According to an embodiment, the wireless communication circuit 320 may communicate with the external electronic device over a first network (e.g., 198 of FIG. 1) (e.g., a short range communication network such as Bluetooth, wireless fidelity (WiFi) direct, or infrared data association (IrDA)).

The sound output circuit 330 may output a sound signal to the outside of the electronic device 200. The sound output circuit 330 may include, for example, a speaker or a receiver.

The battery 340 may supply power to at least one component of the electronic device 200. According to an embodiment, the battery 340 may include, for example, a non-rechargeable primary battery, a rechargeable secondary battery, or a fuel cell.

The memory 350 may store various pieces of data used by at least one component (e.g., the processor 300 or the at least one sensor 310) of the electronic device 200. The data may include, for example, software (e.g., a program (e.g., 140 of FIG. 1)) and input data or output data for a command associated with it.

According to an embodiment, the processor 300 may be configured to detect a distance between an external object (e.g., a user) and the electronic device 200 using the at least one sensor circuit 310 (e.g., a proximity sensor), disable the touch sensor or ignore a signal from the touch sensor, when the distance between the external object and the electronic device 200 is less than a certain distance, determine whether the electronic device 200 meets a specified condition based on a sensing value obtained from the at least one sensor circuit 310, and enable the touch sensor (e.g., the touch sensor circuit 315) or recognize a signal from the touch sensor, when the electronic device 200 meets the specified condition. The processor 300 may be further configured to enable the touch sensor or recognize the signal from the touch sensor, when a specified time after starting to disable the touch sensor or ignore the signal from the touch sensor elapses.

According to an embodiment, the processor 300 may be further configured to obtain a sensing value from the at least one sensor circuit 310 (e.g., the proximity sensor) and determine that the electronic device 200 meets the specified condition, when a degree of change in the obtained sensing value is within a certain range during a certain time.

According to an embodiment, the processor 300 may be further configured to obtain a sensing value from the at least one sensor circuit 310 (e.g., an acceleration sensor or a gyro sensor), obtain information about a roll angle or a pitch angle of the electronic device 200 based on the sensing value, and determine that the electronic device 200 meets the specified condition, when a degree of change in the roll angle or the pitch angle of the electronic device 200 is within a certain range during a certain time.

According to an embodiment, the processor 300 may be further configured to obtain a sensing value using the at least one sensor circuit 310, identify a posture of the electronic device 200 based on the sensing value, and determine that the electronic device 200 meets the specified condition, when the posture of the electronic device 200 is a predetermined posture. The posture of the electronic device 200 may refer to a slope of the electronic device 200.

According to an embodiment, the processor 300 may be further configured to audibly provide a notification using the sound output circuit 330, when it is determined that the specified condition is met.

According to an embodiment, the processor 300 may be further configured to receive a touch input using the enabled touch sensor, obtain a touch input value based on the received touch input, execute a function according to the touch input, when the obtained touch input value is greater than or equal to a first threshold, obtain a degree of change in roll angle or pitch angle of the electronic device 200 using the at least one sensor circuit 310 (e.g., the acceleration sensor or the gyro sensor), when the obtained touch input value is less than the first threshold, and execute the function according to the touch input, when the obtained degree of change in roll angle or pitch angle is less than a second threshold. The processor 300 may be further configured to identify a usage mode of the electronic device 200 and determine the first threshold and the second threshold based on the usage mode. The usage mode may be referred to as, for example, a call mode and/or an exercise mode.

According to an embodiment, the processor 300 may be further configured to identify whether the electronic device 200 is a low-power mode and increase a sensing period of the at least one sensor circuit 310, when the electronic device 200 is the low-power mode.

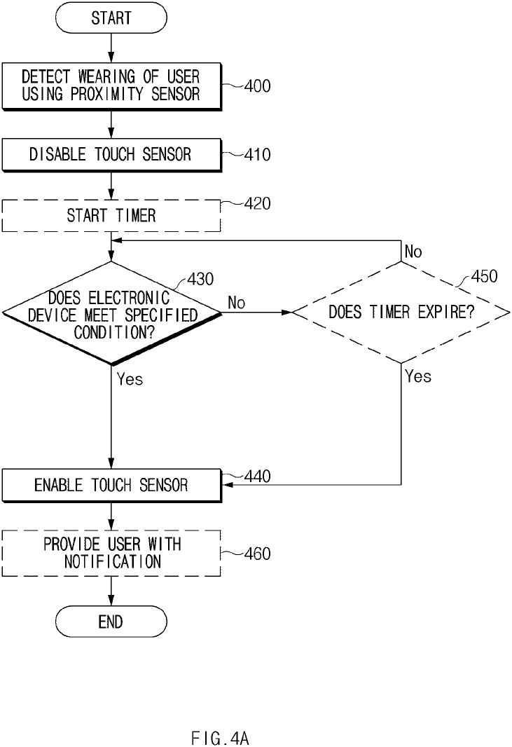

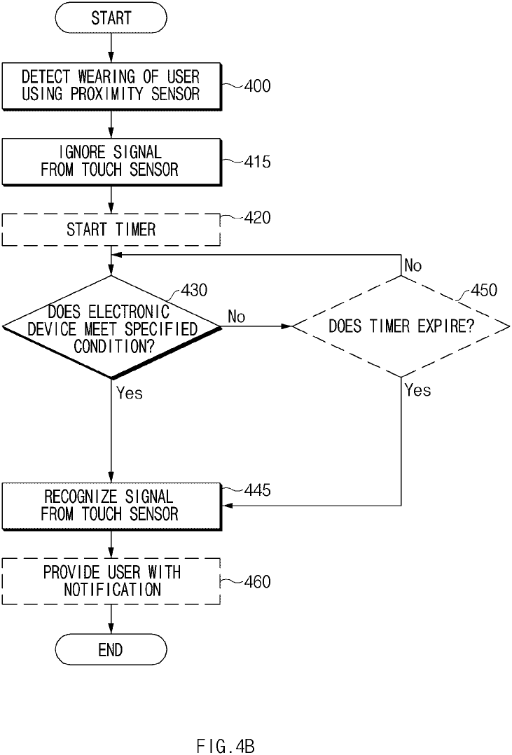

FIGS. 4A and 4B are flowcharts illustrating example operations of an electronic device for preventing/reducing a malfunction according to various embodiments.

Referring to FIG. 4A, in operation 400, a processor (e.g., a processor 300 of FIG. 3) may detect wearing of a user using a proximity sensor (e.g., at least one sensor circuit 310 of FIG. 3). For example, the proximity sensor (or an infrared sensor) may emit and detect an infrared ray and may measure that an external object (e.g., the user) is close. When the user wears the electronic device 200, the infrared ray emitted by the proximity sensor may be reflected by a body’s part (e.g., an ear) of the user, and the proximity sensor may detect it to detect that the user is close. When detecting that the external object (e.g., the user) is close within a certain distance using the proximity sensor, the processor 300 may determine that the user wears the electronic device 200.

In operation 410, the processor 300 may disable a touch sensor (e.g., a touch sensor circuit 315 of FIG. 3). The user may adjust a location of the electronic device 200 to ensure a more comfortable fit. In the process where the user adjusts the location of the electronic device 200, an unintended touch input on the touch sensor may occur. To prevent a malfunction of the electronic device 200 due to the unintended touch input of the user, the processor 300 may disable the touch sensor in operation 410.

In operation 420, the processor 300 may start a timer. The timer may expire after a specified time elapses. The processor 300 may identify whether the timer expires to prevent/avoid operation 430 from being indefinitely repeated and may enable the touch sensor, when the specified time elapses. Operation 420 and operation 460 may be optional operations, which may be omitted.

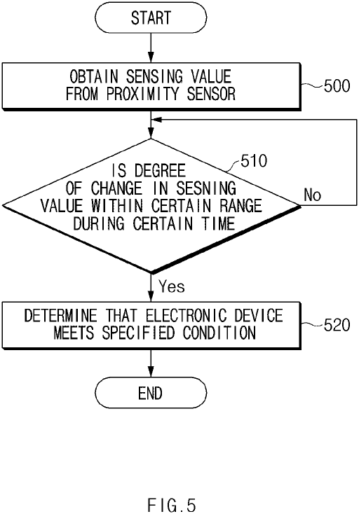

In operation 430, the processor 300 may identify whether the electronic device 200 meets a specified condition. A more detailed description of the specified condition will be provided below with reference to FIGS. 5, 6, 7 and 8.

When the electronic device 200 does not meet the specified condition (430 - NO), the processor 300 may proceed to operation 450. In operation 450, the processor 300 may identify whether the timer expires. When the timer does not expire (450 - NO), the processor 300 may return to before operation 430 to repeat operation 430. When the timer expires (450 - YES), the processor 300 may proceed to operation 440.

When the electronic device 200 meets the specified condition (430 -YES), the processor 300 may proceed to operation 440. For example, when the electronic device 200 meets the specified condition, it may be understood that the wearing of the electronic device 200 of the user is completed.

In operation 440, the processor 300 may enable the touch sensor. After operation 440, the processor 300 may receive a user input to the touch sensor and may execute a function of the electronic device 200 according to the user input.

In operation 460, the processor 300 may audibly provide the user with a notification using a sound output circuit (e.g., a sound output circuit 330 of FIG. 3). For example, the processor 300 may provide the user with that the touch sensor is enabled and it is able to receive a user input as a notification sound. Operation 460 may be an optional operation, which may be omitted.

Corresponding to reference numerals of FIG. 4A among reference numerals of FIG. 4B may be referenced by the description of FIG. 4A. Hereinafter, a description will be given of a difference between FIG. 4A and FIG. 4B.

Referring to FIG. 4B, in operation 415, the processor 300 may ignore a signal from the touch sensor. For example, when there is an unintended touch input of the user to the touch sensor, the processor 300 may ignore an input signal from the touch sensor. Thus, the processor 300 may fail to perform a malfunction according to the touch input of the user.

In operation 445, the processor 300 may recognize the signal from the touch sensor. For example, when receiving a signal for the touch input of the user from the touch sensor, the processor 300 may perform an operation according to the touch input of the user.

For convenience of description, hereinafter, a description will be given an example embodiment according to FIG. 4A.

FIG. 5 is a flowchart illustrating an example operation of FIG. 4A according to various embodiments.

Operations of FIG. 5 may be understood as operations performed in operation 430 of FIG. 4A.

Referring to operation 500, a processor (e.g., a processor 300 of FIG. 3) may obtain a sensing value from a proximity sensor (e.g., at least one sensor circuit 310 of FIG. 3). When a user adjusts a location of an electronic device (e.g., an electronic device 200 of FIG. 3), a distance between the proximity sensor and an external object (e.g., the user) may be changed. Thus, a sensing value of the proximity sensor may also be changed.

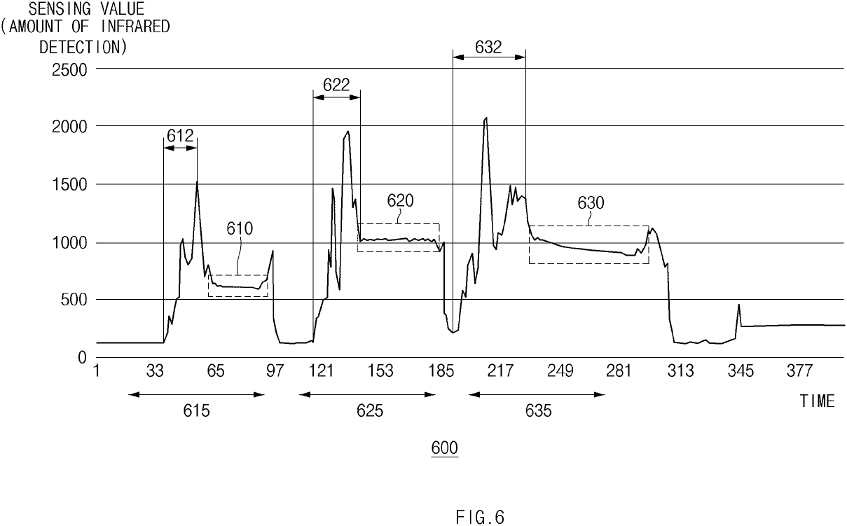

In operation 510, the processor 300 may identify whether a degree of change in the sensing value is within a certain range during a certain time. For example, when the degree of change in the sensing value of the proximity sensor is within the certain range, the processor 300 may determine that the wearing of the electronic device 200 is completed. A description of operation 510 will be provided in greater detail below with reference to FIG. 6.

When the degree of change in the sensing value is out of the certain range (510 - NO), the processor 300 may return to before operation 510 to repeat operation 510. According to an embodiment, when a timer of FIG. 4A expires, the processor 300 may end the operation of FIG. 5 and may enable a touch sensor (e.g., a touch sensor circuit 315 of FIG. 3).

When the degree of change in the sensing value is within the certain range (510 - YES), the processor 300 may proceed to operation 520 to determine that the electronic device 200 meets a specified condition.

FIG. 6 is a graph illustrating a change in sensing value of a proximity sensor according to various embodiments.

In operation 500 of FIG. 5, a processor (e.g., a processor 300 of FIG. 3) may obtain a sensing value from a proximity sensor (e.g., at least one sensor circuit 310 of FIG. 3). The sensing value obtained from the proximity sensor may be referenced by a graph of FIG. 6. The horizontal axis of the graph may be referred to as a time axis (ms), and the vertical axis may be referred to as a sensing value (or the amount of infrared detection).

Referring to a first wearing attempt 615, a sensing value may be greatly changed in an interval 612. For example, when a user wears an electronic device 200, because an external object (e.g., the user) approaches the proximity sensor, the sensing value may greatly increase. In this case, the processor 300 may detect that the user wears the electronic device 200. As another example, when the user adjusts a location of the electronic device 200 to ensure a comfortable fit, after wearing the electronic device 200, the sensing value may be changed. As an example, when the electronic device 200 is away from a body’s part (e.g., ears) of the user due to manipulation of the user, the sensing value may decrease. As an example, when the electronic device 200 is close to the body’s part (e.g., the ears) of the user due to manipulation of the user, the sensing value may increase. While the user adjusts the location of the electronic device 200, the sensing value of the proximity sensor may be continuously changed.

Referring to the first wearing attempt 615, the degree of change in the sensing value may be maintained within a certain range in the interval 610. When the user adjusts the location of the electronic device 200 and ensures a comfortable fit, he or she may not adjust the location of the electronic device 200 any longer. In this case, when the degree of change in the sensing value of the proximity sensor is maintained within the certain range and when the degree of change in the sensing value is maintained within the certain range during a certain time, the processor 300 may determine that the wearing of the user is completed. For example, when the amount of change in the sensing value is maintained over 500 ms within +/- 100, the processor 300 may determine that the electronic device 200 meets a specified condition (operation 520 of FIG. 5).

According to an embodiment, for a second wearing attempt 625 and a third wearing attempt 635, the processor 300 may identify a degree of change in sensing value in the same method. For example, referring to the second wearing attempt 625, the processor 300 may detect the wearing and adjustment of the user in an interval 622. The processor 300 may identify that the degree of change in the sensing value is within a certain range during a certain time in the interval 620 to determine that the electronic device 200 meets the specified condition. For example, referring to the third wearing attempt 635, the processor 300 may detect the wearing and adjustment of the user in an interval 632. The processor 300 may identify that the degree of change in the sensing value is within a certain range during a certain time in the interval 630 to determine that the electronic device 200 meets the specified condition.

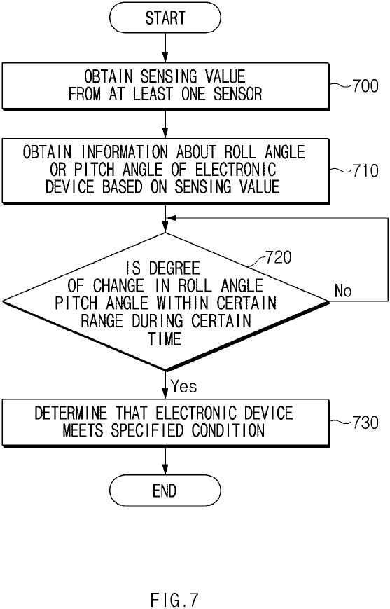

FIG. 7 is a flowchart illustrating an example operation of FIG. 4A according to various embodiments.

Operations of FIG. 7 may be understood as operations performed in operation 430 of FIG. 4A.

Referring to operation 700, a processor (e.g., a processor 300 of FIG. 3) may obtain a sensing value (or a sensing signal) from at least one sensor (e.g., at least one sensor circuit 310 of FIG. 3) (e.g., an acceleration sensor or a gyro sensor). For example, the acceleration sensor may sense acceleration for the direction of 3 axes (e.g., the X-axis, the Y-axis, and the Z-axis) of an electronic device 200 moving in 3 dimensions. For example, the gyro sensor may sense an angular speed of the electronic device 200. The processor 300 may obtain a roll angle or a pitch angle of the electronic device 200 based on the sensing value of the acceleration sensor and/or the gyro sensor.

According to an embodiment, an electronic device (e.g., an electronic device 200 of FIG. 2) may further include a low pass filter (LPF). The sensing value obtained from the at least one sensor circuit 310 by the processor 300 may be understood as a signal of a low-frequency domain. The processor 300 may obtain a filtered signal by passing the sensing value through the LPF. The processor 300 may obtain a roll angle or a pitch angle based on the filtered signal.

In operation 710, the processor 300 may obtain a roll angle or a pitch angle of the electronic device 200 based on the sensing value. The processor 300 may calculate how much the electronic device 200 is inclined with respect to the direction of gravity based on the roll angle or the pitch angle. For example, the processor 300 may identify a degree of change in the roll angle or the pitch angle and may calculate whether the electronic device 200 is rotated or manipulated in a certain direction by the user.

In operation 720, the processor 300 may identify whether the degree of change in the roll angle or the pitch angle is within a certain range during a certain time. For example, when the degree of change in the roll angle or the pitch angle is within the certain range during the certain time, the processor 300 may determine that the wearing of the electronic device 200 is completed.

When the degree of change in the roll angle or the pitch angle is out of the certain range during the certain time (720 - NO), the processor 300 may return to before operation 720 to repeat operation 720. According to an embodiment, when a timer of FIG. 4A expires, the processor 300 may end the operation of FIG. 7 and may enable a touch sensor (e.g., a touch sensor circuit 315 of FIG. 3).

When the degree of change in the roll angle or the pitch angle is within the certain range (720 - YES), the processor 300 may proceed to operation 730 to determine that the electronic device 200 meets a specified condition.

According to an embodiment, the operations of FIG. 7 may be understood as operations which assist the operations of FIG. 6. For example, when corresponding to operation 510 of FIG. 5 (510 - YES) and corresponding to operation 720 of FIG. 7 (720 - YES), the processor 300 may determine that the electronic device 200 meets the specified condition.

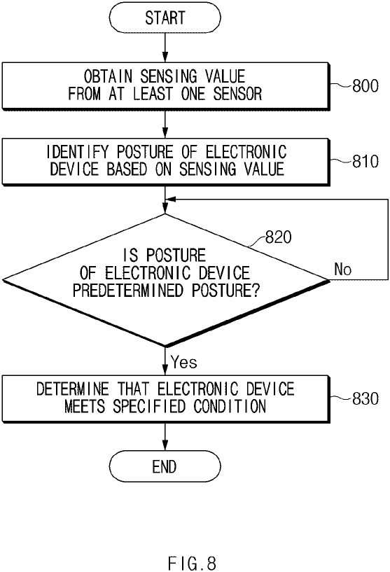

FIG. 8 is a flowchart illustrating an example operation of FIG. 4A according to various embodiments.

Operations of FIG. 8 may be understood as operations performed in operation 430 of FIG. 4A.

Referring to operation 800, a processor (e.g., a processor 300 of FIG. 3) may obtain a sensing value from at least one sensor (e.g., at least one sensor circuit 310 of FIG. 3) (e.g., an acceleration sensor or a gyro sensor).

In operation 810, the processor 300 may identify a posture of an electronic device 200 based on the sensing value. For example, the processor 300 may obtain a roll angle or a pitch angle of the electronic device 200 based on the obtained sensing value. The processor 300 may calculate how much the electronic device 200 is inclined with respect to the direction of gravity based on a change in the roll angle or the pitch angle. For example, the processor 300 may calculate a degree of slope of the electronic device 200 and may identify a posture of the electronic device 200.

In operation 820, the processor 300 may identify whether the posture of the electronic device 200 is a predetermined (e.g., specified) posture. According to an embodiment, the electronic device 200 (e.g., wireless earphones) may include a left-use unit (e.g., a left-use unit 220 of FIG. 2) and a right-use unit (e.g., a right-use unit 230 of FIG. 2). The left-use unit 220 and the right-use unit 230 may be designed to be suitable for the left ear or the right ear of a user. When the left-use unit 220 and the right-use unit 230 are worn on the left ear or the right ear of the user, they may have a specific slope value with respect to the direction of gravity. The processor 300 may obtain the specific slope value when the left-use unit 220 and the right-use unit 230 are worn on the left ear or the right ear of the user using the acceleration sensor or the gyro sensor. The processor 300 may store the specific slope value in a memory (e.g., a memory 350 of FIG. 3). According to an embodiment, to identify whether the posture of the electronic device 200 is the predetermined posture, the processor 300 may compare a current slope value of the electronic device 200 (e.g., the left-use unit 220 and the right-use unit 230) with the specific slope value stored in the memory 350. When a difference between the current slope value of the electronic device 200 and the specific slope value stored in the memory 350 is within a certain range, the processor 300 may determine that the posture of the electronic device 200 is the predetermined posture.

When the posture of the electronic device 200 does not correspond to the predetermined posture (820 - NO), the processor 300 may return to before operation 820 to repeat operation 820. According to an embodiment, when a timer of FIG. 4A expires, the processor 300 may end the operation of FIG. 8 and may enable a touch sensor (e.g., a touch sensor circuit 315 of FIG. 3).

When the posture of the electronic device 200 corresponds to the predetermined posture (820 - YES), the processor 300 may proceed to operation 830 to determine that the electronic device 200 meets a specified condition.

According to an embodiment, the operations of FIG. 8 may be understood as operations which assist the operations of FIG. 5. For example, when corresponding to operation 510 of FIG. 5 (510 - YES) and corresponding to operation 820 of FIG. 8 (820 - YES), the processor 300 may determine that the electronic device 200 meets the specified condition.

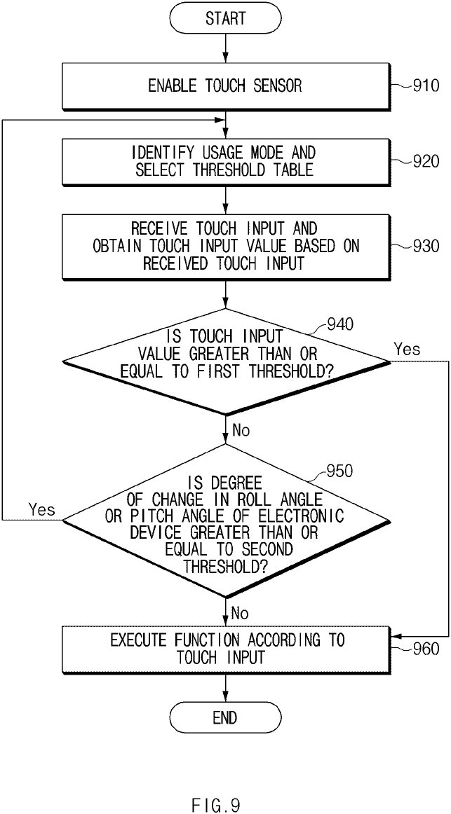

FIG. 9 is a flowchart illustrating an example method for improving accuracy of a touch input according to various embodiments.

Referring to operation 910, in operation 910, a processor (e.g., a processor 300 of FIG. 3) may enable a touch sensor (e.g., a touch sensor circuit 315 of FIG. 3). Operation 910 may be understood as corresponding to operation 450 of FIG. 4A.

Referring to operation 920, the processor 300 may identify a usage mode of an electronic device 200 and may select a threshold table according to it. The threshold table may include information about a first threshold and a second threshold and may be obtained from a memory (e.g., a memory 350 of FIG. 3). The usage mode of the electronic device 200 may be referred to as, for example, a call mode and/or an exercise mode. According to an embodiment, the processor 300 may receive information about the call mode from an external electronic device (e.g., an external electronic device 102 of FIG. 1) through a wireless communication circuit (e.g., a wireless communication circuit 320 of FIG. 3). The processor 300 may determine the first threshold and the second threshold depending on whether the electronic device 200 is on a call. According to an embodiment, the processor 300 may identify whether a user of the electronic device 200 is in an exercise mode using at least one sensor (e.g., at least one sensor circuit 310 of FIG. 3). For example, the processor 300 may detect motion of the electronic device 200 based on the degree of change in sensing value of an acceleration sensor and a gyro sensor. When the motion of the electronic device 200 is greater than or equal to a certain level, the processor 300 may determine that the user is exercising. When the electronic device 200 is on a call or the user is exercising, the processor 300 may set the first threshold or the second threshold to be high to ignore an unintended touch of the user. The description of the usage mode is illustrative, and an embodiment of the disclosure is not limited thereto.

In operation 930, the processor 300 may receive a touch input and may obtain a touch input value based on the received touch input. The processor 300 may receive a touch input of the user through the touch sensor. According to an embodiment, the processor 300 may convert the touch input into an electrical signal to obtain a touch input value. For example, the processor 300 may include a touch integrated circuit (IC) (e.g., the touch sensor circuit 315 of FIG. 3). According to an embodiment, when the touch input value is greater than or equal to 60, the processor 300 may recognize the received touch as a valid touch input. When the touch input value is less than 60, the processor 300 may fail to perform operation 930.

In operation 940, the processor 300 may identify whether the touch input value is greater than or equal to the first threshold. For example, when the electronic device 200 is not on the call in operation 920, the processor 300 may determine the first threshold as 90. For another example, when the electronic device 200 on the call in operation 920, the processor 300 may determine the first threshold as 110.

When the touch input value is greater than or equal to the first threshold (940 - YES), the processor 300 may proceed to operation 960 to execute a function of the electronic device 200 according to the touch input.

When the touch input value is less than the first threshold (940 - NO), the processor 300 may proceed to operation 950. In operation 950, the processor 300 may identify whether a degree of change in roll angle or pitch angle of the electronic device 200 is greater than or equal to the second threshold. The processor 300 may obtain a roll angle or a pitch angle of the electronic device 200 using at least one sensor circuit 310 (e.g., an acceleration sensor or a gyro sensor). The second threshold may be determined in operation 920.

When the degree of change in roll angle or pitch angle of the electronic device 200 is greater than or equal to the second threshold (950 - YES), the processor 300 may return to before operation 920 to proceed to operation 920. For example, when the user adjusts the location of the electronic device 200 again, the degree of change in roll angle or pitch angle of the electronic device 200 may be greater than or equal to the second threshold. When the degree of change in roll angle or pitch angle of the electronic device 200 may be greater than or equal to the second threshold, the processor 300 may determine that there is a high probability that the corresponding touch input will occur by an unintended touch of the user.

When the degree of change in roll angle or pitch angle of the electronic device 200 is less than the second threshold (950 - NO), the processor 300 may proceed to operation 960 to execute the function of the electronic device 200 according to the touch input.

The processor 300 may perform the operations according to FIG. 9 to prevent and/or reduce a malfunction of the electronic device 200 due to an unintended touch input of the user even after the wearing of the electronic device 200 is completed.

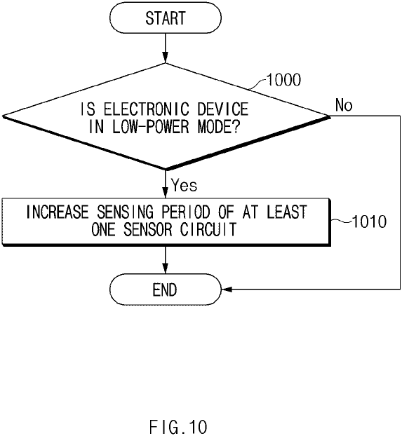

FIG. 10 is a flowchart illustrating and example operation of an electronic device according to a power state according to various embodiments.

Referring to operation 1000, a processor (e.g., a processor 300 of FIG. 3) may identify whether an electronic device (e.g., an electronic device 200 of FIG. 2) is in a low-power mode. The low-power mode may be referred to as the case where a charging rate of a battery (e.g., a battery 340 of FIG. 3) is less than a reference value. For example, when the charging rate of the battery of the electronic device 200 is less than 15%, the processor 300 may determine that the electronic device 200 is in the low-power mode.

When the electronic device 200 is not in the low-power mode (1000 -NO), the processor 300 may end the operation.

When the electronic device 200 is in the low-power mode (1000 - YES), the processor 300 may proceed to operation 1010. In operation 1010, the processor 300 may increase a sensing period of at least one sensor circuit (e.g., at least one sensor circuit 310 of FIG. 3). According to an embodiment, when the electronic device 200 is not in the low-power mode, the processor 300 may obtain a sensing value of the at least one sensor circuit 310 at a specified period (e.g., a frequency of 200 Hz). When the electronic device 200 is in the low-power mode, the processor 300 may obtain a sensing value of the at least one sensor circuit 310 at a period (e.g., a frequency of 100 Hz) which more increases than the specified period. The processor 300 may increase the sensing period in the low-power mode to reduce power consumption due to sensing. According to an embodiment, the processor 300 may use only some (e.g., an acceleration sensor) of the at least one sensor circuit 310 to determine whether the electronic device 200 meets a specified condition in the low-power mode.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device, comprising:
at least one sensor including a proximity sensor;
a touch sensor; and
a processor operatively connected with the at least one sensor and the touch sensor,
wherein the processor is configured to:
detect a distance between an external object and the electronic device using the proximity sensor;
disable the touch sensor or ignore a signal from the touch sensor based on the distance between the external object and the electronic device being less than a specified distance;
determine whether the electronic device meets a specified condition based on a sensing value obtained from the at least one sensor; and
enable the touch sensor or recognize the signal from the touch sensor, based on the electronic device meeting the specified condition.

2. The electronic device of claim 1, wherein the processor is further configured to:
enable the touch sensor or recognize the signal from the touch sensor, based on a specified time after starting to disable the touch sensor or ignore the signal from the touch sensor elapsing.

3. The electronic device of claim 1, wherein the processor is further configured to:
obtain the sensing value from the proximity sensor; and
determine that the electronic device meets the specified condition based on a degree of change in the obtained sensing value being within a specified range during a specified time.

4. The electronic device of claim 1, wherein the at least one sensor further includes an acceleration sensor and a gyro sensor.

5. The electronic device of claim 4, wherein the processor is further configured to:
obtain the sensing value from the at least one sensor;
obtain a roll angle or a pitch angle of the electronic device based on the sensing value; and
determine that the electronic device meets the specified condition based on a degree of change in the roll angle or the pitch angle of the electronic device being within a specified range during a specified time.

6. The electronic device of claim 4, wherein the processor is further configured to:
obtain the sensing value using the at least one sensor;
identify a posture of the electronic device based on the sensing value; and
determine that the electronic device meets the specified condition based on the posture of the electronic device being a specified posture.

7. The electronic device of claim 1, further comprising:
a sound output circuit,
wherein the processor is further configured to:
provide an audible notification using the sound output circuit based on determining that the specified condition is met.

8. The electronic device of claim 4, wherein the processor is further configured to:
receive a touch input using the enabled touch sensor;
obtain a touch input value based on the received touch input;
execute a function according to the touch input based on the obtained touch input value being greater than or equal to a first threshold;
obtain a degree of change in roll angle or pitch angle of the electronic device using the at least one sensor based on the obtained touch input value being less than the first threshold; and
execute the function according to the touch input based on the obtained degree of change in roll angle or pitch angle being less than a second threshold.

9. The electronic device of claim 8, wherein the processor is further configured to:
identify a usage mode of the electronic device; and
determine the first threshold and the second threshold based on the usage mode.

10. The electronic device of claim 1, wherein the processor is further configured to:
identify whether the electronic device is in a low-power mode; and
increase a sensing period of the at least one sensor based on the electronic device being in the low-power mode.

11. A method of operating an electronic device, the method comprising:
detecting a distance between an external object and the electronic device using a proximity sensor included in at least one sensor of the electronic device;
disabling a touch sensor or ignoring a signal from the touch sensor based on the distance between the external object and the electronic device being less than a specified distance;
determining whether the electronic device meets a specified condition based on a sensing value obtained from at least one sensor; and
enabling the touch sensor or recognizing the signal from the touch sensor based on the electronic device meeting the specified condition.

12. The method of claim 11, further comprising:
enabling the touch sensor or recognizing the signal from the touch sensor based on a specified time after starting to disable the touch sensor or ignore the signal from the touch sensor elapsing.

13. The method of claim 11, further comprising:
obtaining the sensing value from the proximity sensor; and
determining that the electronic device meets the specified condition based on a degree of change in the obtained sensing value being within a specified range during a specified time.

14. The method of claim 11, wherein the at least one sensor further includes an acceleration sensor and a gyro sensor.

15. The method of claim 14, further comprising:
obtaining the sensing value from the at least one sensor;
obtaining a roll angle or a pitch angle of the electronic device based on the sensing value; and
determining that the electronic device meets the specified condition based on a degree of change in the roll angle or the pitch angle of the electronic device being within a specified range during a specified time.

16. The method of claim 14, further comprising:
obtaining the sensing value using the at least one sensor;
identifying a posture of the electronic device based on the sensing value; and
determining that the electronic device meets the specified condition based on the posture of the electronic device being a specified posture.

17. The method of claim 11, further comprising:
providing an audible notification using a sound output circuit of the electronic device based on determining that the specified condition is met.

18. The method of claim 14, further comprising:
receiving a touch input using the enabled touch sensor;
obtaining a touch input value based on the received touch input;
executing a function according to the touch input based on the obtained touch input value being greater than or equal to a first threshold; and
obtaining a degree of change in roll angle or pitch angle of the electronic device using the at least one sensor based on the obtained touch input value being less than the first threshold, and executing the function according to the touch input based on the obtained degree of change in roll angle or pitch angle being less than a second threshold.

19. The method of claim 18, further comprising:
identifying a usage mode of the electronic device; and
determining the first threshold and the second threshold based on the usage mode.

20. The method of claim 18, further comprising:
identifying whether the electronic device is in a low-power mode; and
increasing a sensing period of the at least one sensor based on the electronic device being in the low-power mode.
